(19) United States
(12) Patent Application Publication
(10) Pub. No.: US 2021/0021594 A1
(43) Pub. Date: Jan. 21, 2021

(54) BIOMETRIC SECURITY FOR EDGE PLATFORM MANAGEMENT

(71) Applicants: Francesc Guim Bernat, Barcelona (ES); Ned M. Smith, Beaverton, OR (US); Kshitij Arun Doshi, Tempe, AZ (US); Suraj Prabhakaran, Aachen (DE); Brinda Ganesh, Portland, OR (US)

(72) Inventors: Francesc Guim Bernat, Barcelona (ES); Ned M. Smith, Beaverton, OR (US); Kshitij Arun Doshi, Tempe, AZ (US); Suraj Prabhakaran, Aachen (DE); Brinda Ganesh, Portland, OR (US)

(21) Appl. No.: 17/032,696

(22) Filed: Sep. 25, 2020

(51) Int. Cl. H04L 29/06

(52) U.S. Cl. CPC H04L 63/0861; H04L 63/0876; H04L 63/164; H04L 63/105; H04L 63/0853

(57) ABSTRACT

Various aspects of methods, systems, and use cases for biometric security for edge platform management. An edge cloud system to implement biometric security for edge platform management comprises a biometric sensor; and an edge node in an edge network, the edge node to: receive a request to access a feature of the edge node, the request originating from an entity, wherein the request comprises an entity identifier and a feature identifier; receive from the biometric sensor, biometric data of the entity; authenticate the entity using the biometric data; and in response to authenticating the entity using the biometric data, grant access to the feature based on a crosscheck to an access control list that includes entity identifiers correlated to feature identifiers, using the received entity identifier and the received feature identifier.

### BACKGROUND

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in an high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 50 network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

As edge networks grow, there are more hardware assets in use. Some edge hardware is remotely located and may be in an insecure or unsecured location. What is needed is a better way to secure the physical hardware assets.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7A provides an overview of example components for compute deployed at a compute node in an edge computing system.

FIG. 7B provides a further overview of example components within a computing device in an edge computing system.

FIG. 8 is a block diagram illustrating an edge node, according to an embodiment.

FIG. 9 is a flow chart illustrating a method for authenticating an entity at an edge node, according to an embodiment.

FIG. 10 is a flow chart illustrating a method for biometric security for edge platform management performed in an edge computing environment, according to an embodiment.

### DETAILED DESCRIPTION

The following embodiments generally relate to using biometric security to secure computing hardware resources in a distributed edge computing environment.

The following addresses two key vulnerabilities. The first concerns subversion of the process of giving biometric information, where the person whose biometrics are being sought is coerced or misled by a third-party, or is prevented knowingly or unknowingly from being able to access due to an attacker being able to generate sufficient noise to compromise a biometric sensor's ability to infer within a noise tolerance level. The second vulnerability, in due course of time, is the use of robots or other non-biological agents that may take on tasks currently performed by humans. In this case, assuming that the system designers have created an alternative way of accessing a platform for non-human agents, such as a certificate and a challenge response mechanism, the attacker can target the robot itself (in other words, the attack morphs).

Physical protection of computing resources should be two-layered so that even if an attacker can subvert the first layer by applying some physical measures, the second layer of admission control removes some elements of control from the attacker before permitting the access. For example, to access a resource, a user may need a retina scan to enter first chamber, and the chamber insulates against any possibility of disturbance, so that a second independent, authentication, access granting, and tamper attempt detecting layer can now enforce the access protection without having to be noise-compensating.

Conventional authentication uses electronic mechanisms (e.g., password entry, card scanning, etc.) but often the same authentication mechanisms are used regardless of the task being performed. Physical security is important to guarantee uptime, improved latency and quality of service (QoS), and other reliability factors. One of the key elements relevant to edge computing is how to securely allow upgrades or changes of platforms in distributed location. An improved system described here provides increased physical security.

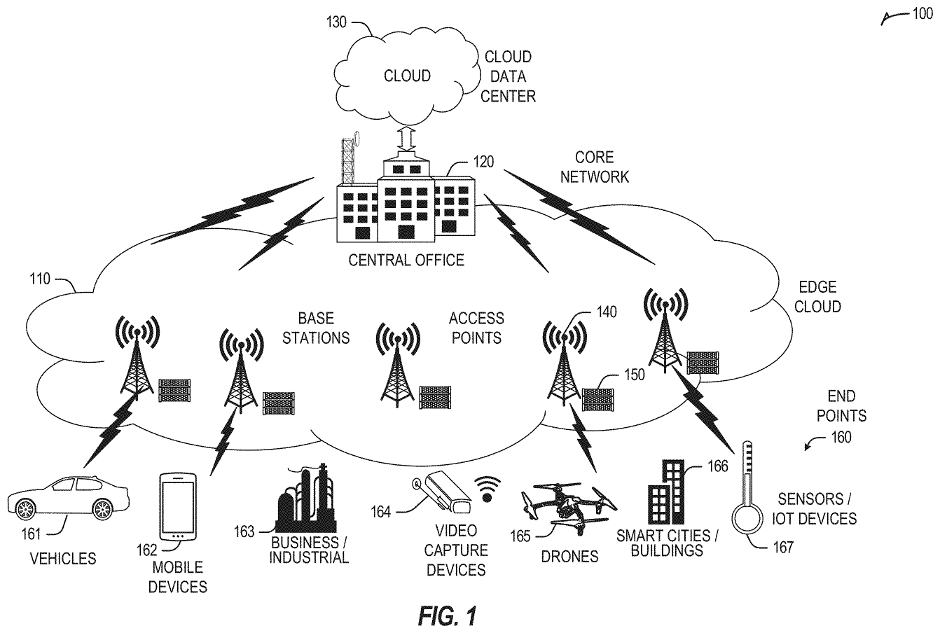

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

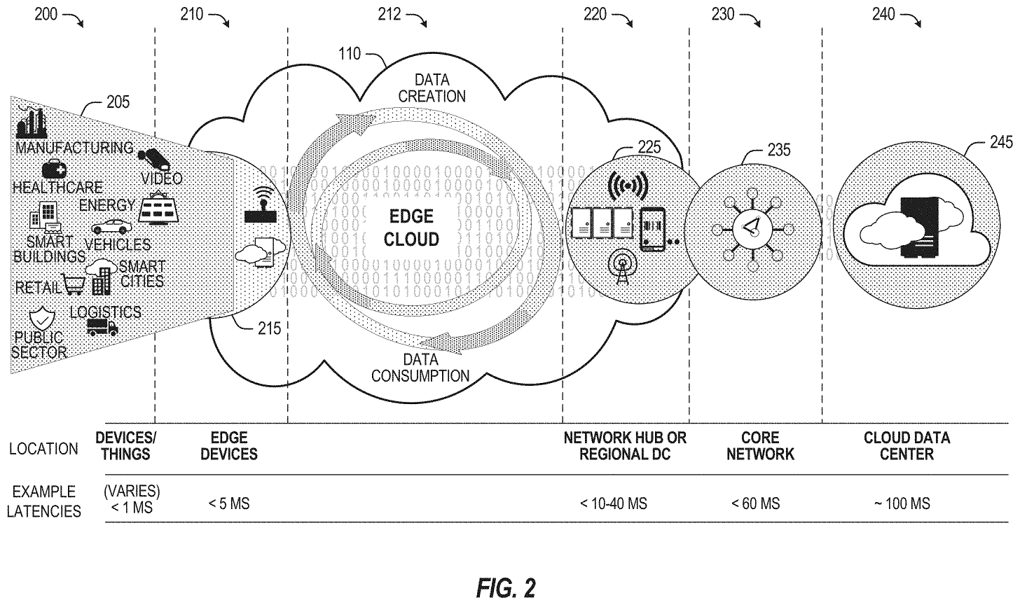

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

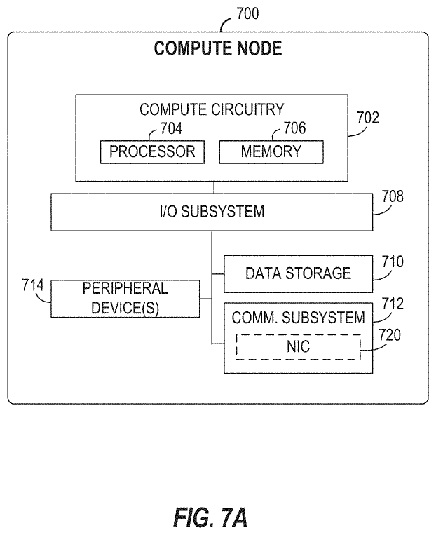

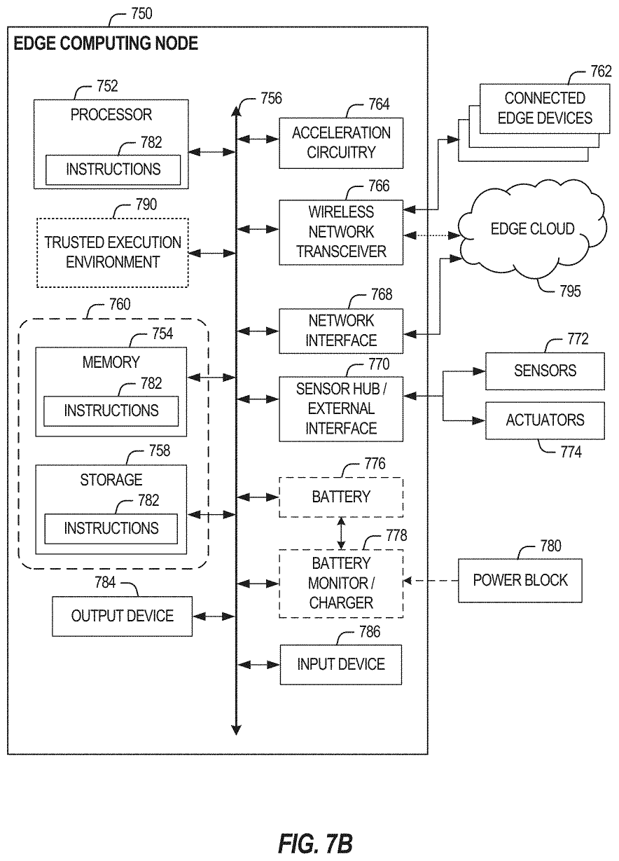

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

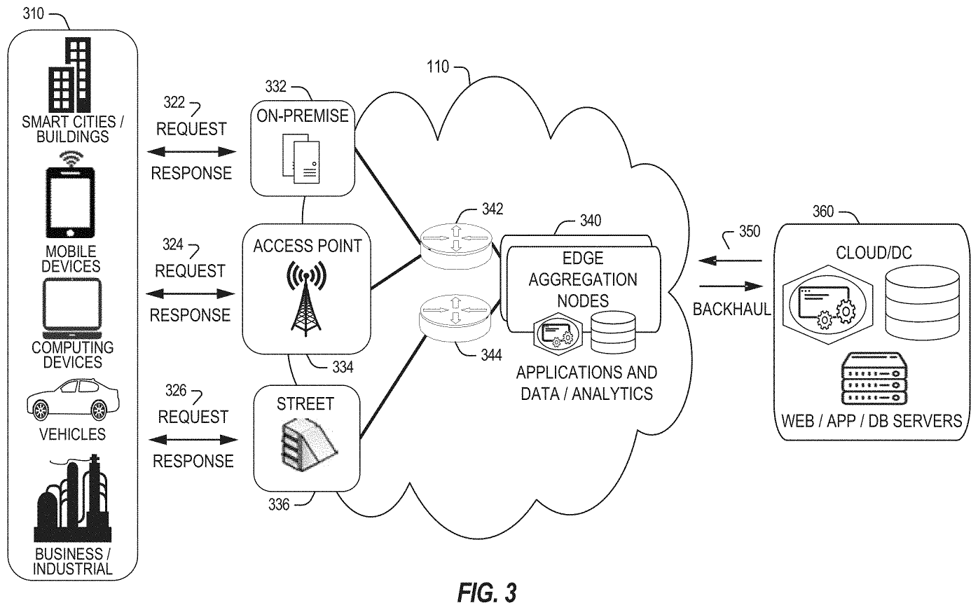

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

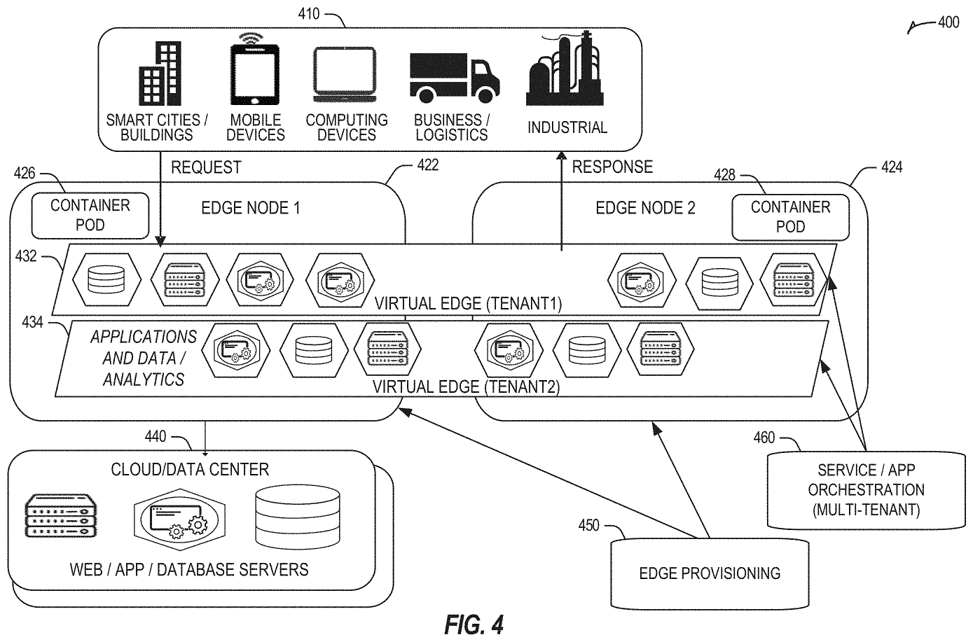

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

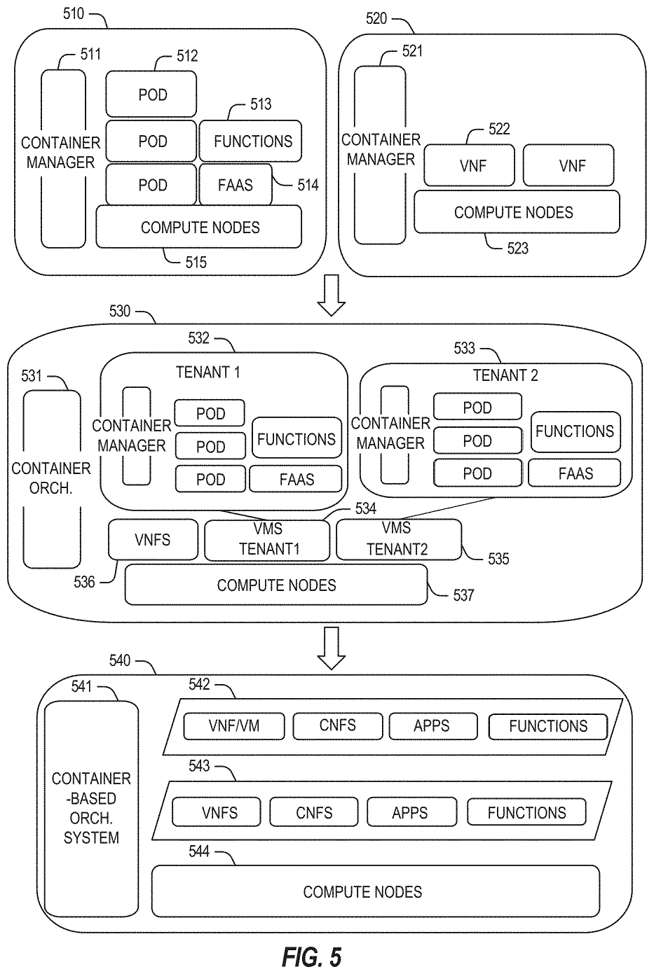

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

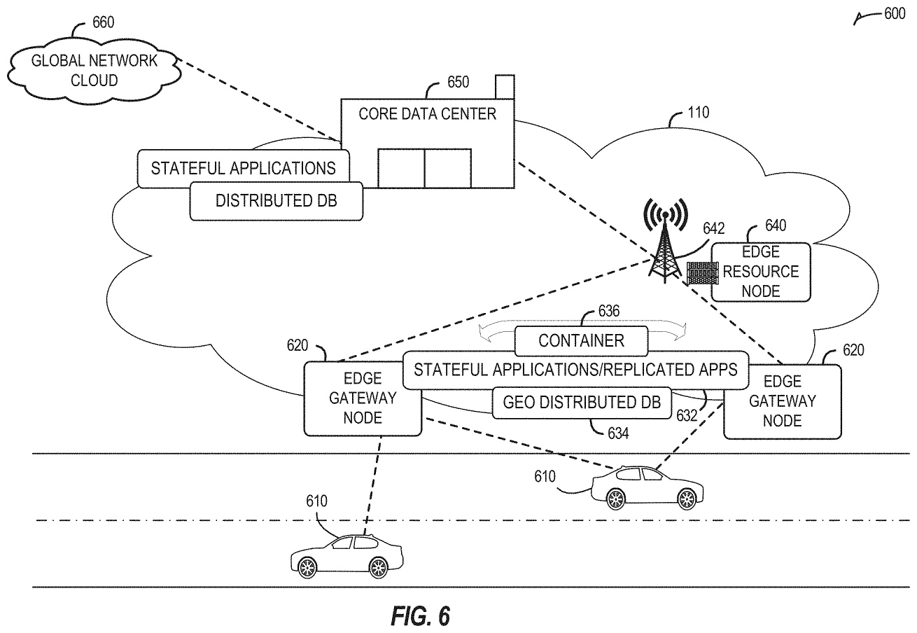

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a ToT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel Architecture Core™ based CPU processor, such as a Quark™, an Atom™, an i3, an i5, an i7, an i9, or an MCU-class processor, or another such processor available from Intel. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD794A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs. or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

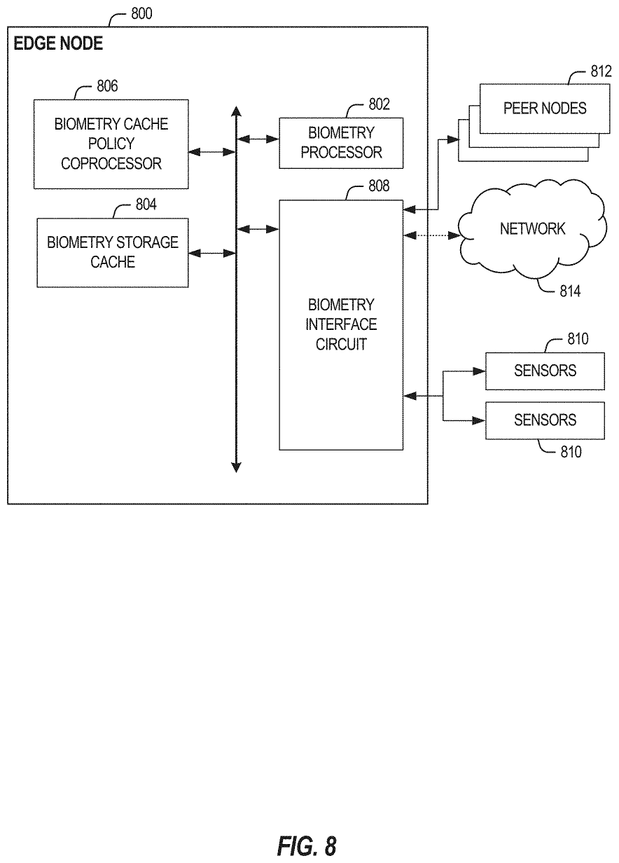

FIG. 8 is a block diagram illustrating an edge node 800, according to an embodiment. In various implementations the edge node 800 may be incorporated in a cellular tower, base station, a telecom central office (CO), a designated edge node server, an enterprise server, a roadside server, or a local or peer at-the-edge device being served consuming edge services. The edge node 800 is used to control access to hardware, software, or other components of equipment that are often located at remote locations.

The edge node 800 includes biometry processor 802, a biometry storage cache 804, a biometry cache policy coprocessor 806, and a biometry interface circuit 808. These components work in combination in order to introduce a layer of biometric security onto the physical hardware of the edge node 800.

The biometry processor 802 may be embodied as, include, or be coupled to an FPGA, an ASIC, reconfigurable hardware or hardware circuitry, or other specialized hardware to facilitate performance of the functions described herein. Alternatively, the biometry processor 802 may be implemented as software or firmware executing in a TEE 790. The biometry storage cache 804 be embodied as any type of volatile or non-volatile memory or data storage capable of performing the functions described herein. The biometry cache policy coprocessor 806 may be embodied as, include, or be coupled to an FPGA, an ASIC, reconfigurable hardware or hardware circuitry, or other specialized hardware, software, or firmware to facilitate performance of the functions described herein. The biometry interface circuit 808 may be embodied as, include, or be coupled to an FPGA, an ASIC, reconfigurable hardware or hardware circuitry, or other specialized hardware to facilitate performance of the functions described herein.

In addition to any biometric sensor there may be aliveness test that is applied by a sensor (in addition to the biometric collection operation that biometric sensors perform). The liveness tests may include, but are not limited to, sampling blood flow or capillary activity, for example in a fingerprint scan, user question-response sessions such as the sensor prompting the user to blink or perform other facial muscle movements, or other liveness tests that may involve other impromptu user interaction tests that cannot easily be predicted. Such liveness tests may include CAPTCHA interactions, randomized PIN Pad/PIN entry, or PAVP (protected audio visual path). In the case of a robot entity attempting to access, the robot may be subject to liveness tests to ensure that the robot is an actual, physically present object. For example, a robot with a pointing capability and visual and sight processor may be able to perform liveness tests using a randomized keyboard to enter a PIN. The robot would not suffer from short term memory limitations and could quickly process the layout of a randomized keyboard having a much larger number of characters than humans can process.

In an implementation, the biometry interface circuit 808 is communicatively coupled to one or more biometric sensors 810. Biometric sensors 810 may include fingerprint readers, microphones, cameras, or the like. Biometric sensors 810 are used to capture biometric information for biometry analysis. Biometric information is physical or behavioral characteristics that can be used to identify a requester (e.g., a person or a robot). Biometry is the use of statistical analysis to biometric data. In the context of this implementation, the biometry is used to determine whether to allow or deny access to a requester. Biometric sensors 810 may include a mobile device, such as a smartphone or cellular device, that is typically in the possession of the requester. The requester may have authenticated to the mobile device and biometric signatures may be passed to the biometry interface circuit 808 as part of an authentication protocol.

The biometry processor 802 is used to interface with the biometry interface circuit 808 and obtain biometric data used for authentication. The biometry processor 802 may then interface with the biometry storage cache 804 to authenticate the requester at the edge node 800.

The biometry storage cache 804 may store biometric signatures, policy data, and other types of information used to control access at the edge node 800. Biometry data may be provided by an owner of the edge node 800 to pre-register users for access to the edge node 800. The biometry storage cache 804 may also store passwords, personal identification numbers (PIN), or other access codes that may be used in conjunction with biometric authentication techniques.

The biometry storage cache 804 may be configured and managed by the biometry cache policy coprocessor 806. Caching policies, such as the amount of time to retain a biometric signature, encryption keys used to encrypt signatures, or other features used to store and protect biometric data or biometry data in the biometry storage cache 804 may be accessed by the biometry cache policy coprocessor 806. The policies, rules, or other configuration data may be stored in the biometry cache policy coprocessor 806.

Access rights are granted based on biometry analysis and are limited to a certain subset of functions or actions that the requester is able to perform. The functions or actions are mapped to certain classes of privilege. Privileges may be grouped or classified into the following: update firmware, update operating system (OS) files, replace device, replace memory module (e.g., DIMM or NVRAM), or the like. For instance, the edge node 800 may require the requester performing the action on the platform to pronounce the given password. If both biometry for the voice and the token match the expected values, the action is allowed, and no alert is generated. In some implementations, the operator is expected to update the token after each access to make the strengthen the security. Additional anti-spoofing mechanisms may be used to secure the biometric attacks.

The biometric authentication may be implemented in an edge platform, which is available to several edge clients. To use the biometric authentication functions of the edge platform, several interfaces are established between the edge platform (e.g., edge node 422) and the clients (e.g., client endpoints 410). The interfaces include a biometry configuration interface and a biometry request interface.

The biometry configuration interface is used to define rules, policies, and configuration data for the edge platform. The biometry configuration interface may be exposed to an administrator user. Using the biometry configuration interface, the administrator may manage access rights, configure caching policies, manage stored biometric signatures, and perform other rule management in the biometry storage cache 804.

Rules stored in the biometry storage cache may include an entity identifier, a feature identifier, a biometry challenge, and biometry authentication data. The rules may also include time and date restrictions so that entities requesting access to a feature may only be granted access during allowable times or dates.

The entity identifier is a unique identifier that is associated with a person, robot, or other entity that may be granted access to a resource. The entity identifier may be an arbitrary identifier, a username, a media access control (MAC) address, an international mobile subscriber identity (IMSI) number, or the like. In general, the entity identifier may be implemented from a globally unique identifier (GUID).

The feature identifier is an identifier that is used to indicate which with features, elements, components, or assets the entity is allowed to interact. Features may include electronic components, such as memory (e.g., DDR memory units), storage (e.g., NVRAM, SSD drives, flash drives), network resources (e.g., network interface cards), or the like. Features may include software or firmware assets, such as a Basic Input-Output System (BIOS) or Unified Extensible Firmware Interface (UEFI), hardware drivers, operating system files, user space executables, or the like. Other features may be defined and enumerated with feature identifiers. An entity may have access to one or more features.

The biometry challenge in the rules refers to the type of biometric data that is captured and how it is captured. For instance, the biometry challenge may include a video identification, a voice authentication, a fingerprint authentication, a retinal scan authentication, facial recognition authentication, or the like. Several biometry challenges may be used in combination. Some biometry challenges, such as facial recognition, may not be applicable to certain types of entities, such as robots. In the case of robots, additional or alternative challenges may be used to uniquely identify the robot.

Robots may be constructed with hardware root-of-trust technology such as PUFs (physically unclonable function) that contains a source of entropy and a mechanism for storing or generating a unique and unclonable identifier. The robot may also implement attestation capabilities that introspects and describes many other properties of the robot (such as its mode of autonomy). Other characteristics may, over time or due to wear, may result in identifiable or characteristic observations may augment a reliable form of authentication (such as PUFs and HW root of trust) such as using microphone to listen for operational noise that is characteristic of a particular type of robot, or to observe motion, latency or other aspects of robot autonomy that are characteristic of the type of robot. However, these are not considered reliable as authenticators in an authentication challenge/response protocol. Further, robots may engage in interactive liveness tests as described above. Liveness tests are used when an authentication challenge is something that normally is replayed by the authenticating entity.

The biometry authentication data is used to crosscheck the information received by the biometric sensor in the biometry challenge. The biometry authentication data may be a photo or image of a person's face to compare against video data received by the biometry challenge. The biometry authentication data may be a model that is stored and used to compare with detected sensor values. For instance, the model may be a series of measurements of features on a person's face. The measurements may be distance between features, or size, shape, color, number of other metrics of features. Similar models may be constructed for a person's blood vessels in a retina, ridges on a finger, or skin cell patterns on a portion of a hand, for example. Tonal values may be captured and stored as a voice model to be compared in voice authentication. Biometric identification information stored as part of the biometry authentication data (also referred to as biometric template data) may be encrypted or otherwise securely stored to prevent unauthorized reads or copies to be made that can be replayed during a challenge/response to impersonate the user.

During authentication, the edge node 800 may interface with other peer edge nodes 812 to obtain biometry authentication data. Each edge node 800, 812 may only store recently used biometry data in the biometry storage cache 804. Recentness is a property of how likely the biometric can change over time. A DNA sequencing challenge does not change significantly over the life of the person. Whereas, a capillary scan can change significantly due to injury or other biologic process that repairs tissues. As such, if there is a cache miss when an entity is attempting to authenticate to the edge node 800 for access to a feature, the edge node 800 may communicate with peers on the edge network to determine if they have biometry data related to the entity. When none of the edge nodes 800 have the biometry data needed to authenticate an entity, the edge node 800 may request biometry data from a core device (e.g., an orchestrator or management system), which may be accessible over a network 814.

The basic idea is if the cached copies of biometric template data become stale, there is a way to locate the entity (human/robot) to prompt for a fresh biometric challenge. The cache may also store a recent ‘biometric template’ that is used to compare the biometric challenge data. The recent biometric template may be stored in a repository that is controlled by an orchestrator or by a user device (e.g. user's mobile phone or smart card). The orchestrator may refresh the biometric template from a smartcard copy if there is a secure channel between them such as a user subscription agreement that involved establishment of keys that are used to create a secure channel. Alternatively, the orchestrator may use an edge node with biometric sensors that the orchestrator knows are not compromised to capture a new biometric template. This new biometric template may be used to warm the biometric template caches for other edge nodes seeking to perform biometric challenge response with the user or user agent hardware (e.g. mobile phone/smart card) that may have stored the challenge result locally. Typically, the liveness test cannot be stored/cached and must be performed when the biometric challenge is supplied to the challenger.

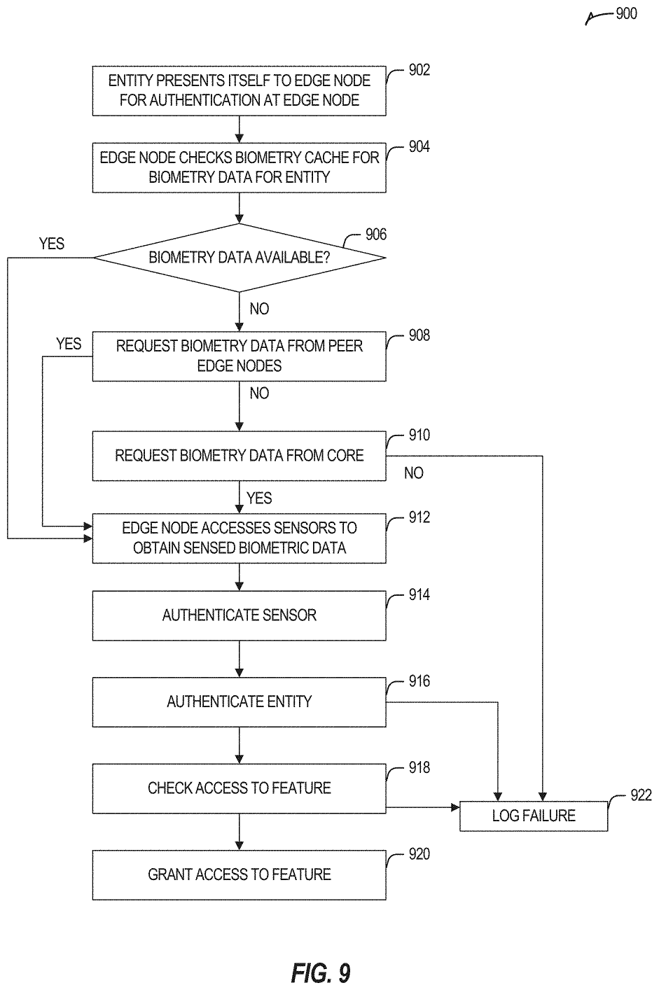

FIG. 9 is a flow chart illustrating a method 900 for authenticating an entity at an edge node, according to an embodiment. The entity may be a person, a robot, or some other entity that attempts to access one or more features of a device, where the access to the device is partially controlled by the edge node. The entity is typically registered with the edge node with an access control data structure. The access control data structure may include a record that stores the entity's identification, permitted access, and biometry data used to authenticate the entity.

At 902, the entity presents itself to the edge node for authentication. The entity may provide a unique identifier and a feature identifier. The feature identifier may be a name, number, bit vector, or other value that indicates those features for which the entity is requesting access. Features may include categories or tasks, such as device update, firmware update, memory update, operating system update, or the like.

At 904, the edge node searches the biometry storage cache on the edge node to determine if the biometry data needed to authenticate the entity is available in the biometry storage cache. If it is, then at decision 906, the method 900 proceeds to operation 912.

If the biometry data is not in the biometry storage cache, then at 908, the edge node requests the biometry data for the entity from peer edge nodes. If a peer edge node is able to provide the biometry data for the entity, then the method proceeds to operation 912. If not, then the method continues and at 910, the edge node requests the biometry data from a core network device or system. The core network device or system may be a platform provider or an orchestrator, for example. The core network device or system provides the biometry data and the method proceeds to operation 912. Because of latency, bandwidth usage, compute usage, and other factors, requesting the biometry data from core is less desirable then requesting the biometry data from peers.

It is determined which biometry data is needed. If ‘biometric template’ data is needed, then peer edge nodes may have a cached copy that is not yet stale. If all peer nodes caches have stale biometric templates, then the ‘core’ node or orchestrator finds the template from the user's long term storage resource. If the template has expired, meaning it is beyond the expected drift for the type of biometric, then the user is prompted to re-register or re-train the template.

In the case where biometry data is a ‘biometric challenge’ data (i.e., ‘biometric sample’ or ‘sample’ data), the peer nodes may have a fresh sample taken within the time that a sample expires. For example, a sample might be valid for ten minutes after it was taken. If the sample is not fresh, then the user must be challenged again to obtain a new sample. In some cases, it is possible to rely on the user's device to take a stream of samples periodically. For example, a mobile phone camera with facial recognition sensor may sample every time motion and ambient light or proximity sensors detect the camera is pointing to the user's face.

The liveness test needs to be performed within the sample expiration period too. This may be more intrusive to the user. However, an alternate sensor may be used for liveness, such as a heart rate monitor sensor that performs capillary scans, which can be combined with a liveness test that uses a facial scan (or fresh cached sample). This multi-factor liveness test combined with pairing context (e.g., that the heart rate monitor sensor is paired with the phone) establishes the full context for the ‘sample’ data.

As such, at 912, the edge node accesses various sensors in order to gather biometric data of the entity. The sensors may be of various types including, but not limited to cameras, microphones, weight sensors, or the like. The entity may interact with the sensor in order to obtain the biometric data. For instance, a person may hold their finger on a fingerprint scanner or rest their face near a retinal scanner to provide biometric data. Alternatively, the sensor may be configured to obtain the biometric data without the entity's participation. For instance, the sensor may be a camera that captures images of the person's face as they enter a room.

Authentication of the sensor 914 is an additional step that verifies there is a trusted path between the sensor and the root of trust processor that handles the rest of the authentication processing. Thus, at 914, the edge node authenticates the sensor or sensors used to obtain the biometric data. This may be performed using attestation data, such as a signature provided by the sensor device to the edge node. The edge node may have a registry of trusted sensor devices and perform a lookup on the registry to authenticate the sensor device. The signature may be a hash of a firmware version, a unique device identifier, an operating system version, or other uniquely identifying information of the sensor device. The edge node may request cooperation from peer edge nodes or from the core network device to authenticate the sensor if the sensor is not immediately recognized by the edge node.

At 916, after the sensor is authenticated, the edge node compares the biometric data obtained by the sensor to the biometry data retrieved in the operation 904, 908, or 910. If there is a match, then the entity is authorized and at 918, the edge node checks to see if the requested feature is accessibly by the entity. If so, then at 920, the entity is granted access to the feature requested. If the biometric check fails or the entity is not allowed to access the feature, then the failed access is logged at 922.

To grant access to the feature, the edge node may provide a signal to a device, which may unlock a portion of the device for the entity to access the feature. For instance, the edge node may signal a device that the entity is allowed to access the device's chassis to install new memory modules (e.g., SIMM, DIMM, DDR RAM, etc.). A chassis intrusion system may be disabled for a time period to allow the person to access the motherboard and swap in new memory modules. Additional access rights may be provided to access this feature. For example, the person may need to reboot the device to ensure that the memory modules are installed completely and correctly. The person may also need to access BIOS or UEFI to configure or test the memory module. As such, these features may be unlocked temporarily for the person to completely install and test the memory modules.

Instead of copying the biometry data from peer edge nodes in operation 908, the peer edge nodes may instead provide an indication that biometry data is available. Then, later in operation 916, the edge node may pass the sensor data to the peer edge node to check against the biometry data. The peer may then pass back an authentication pass or fail signal.

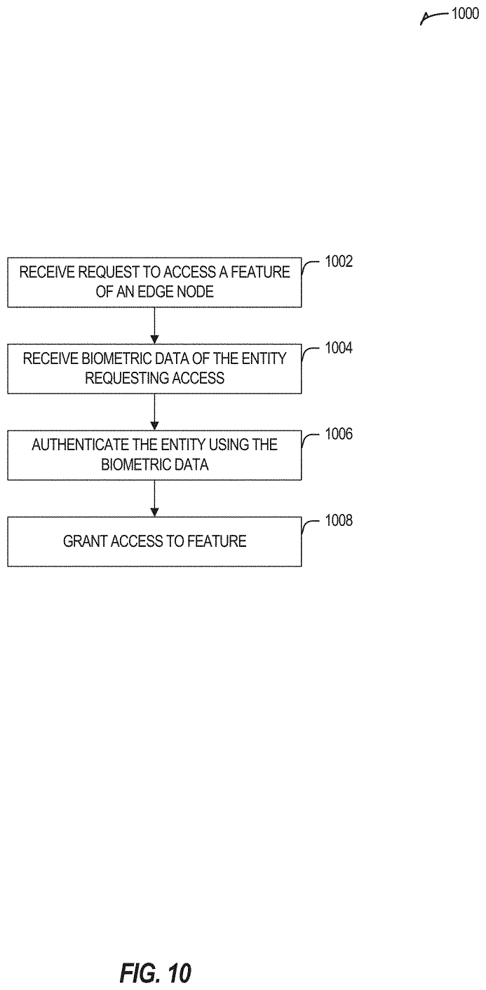

FIG. 10 is a flow chart illustrating a method 1000 for biometric security for edge platform management performed in an edge computing environment, according to an embodiment. The method 1000 may be performed by an edge node in an edge cloud, as discussed above in FIG. 1.

At 1002, an edge node in an edge network receives a request to access a feature of the edge node, the request originating from an entity, wherein the request comprises an entity identifier and a feature identifier.

In an embodiment, the feature comprises a hardware element of the edge node. In a further embodiment, the hardware element is a memory module. In another embodiment, the hardware element is a storage device.

In an embodiment, the feature comprises a software element of the edge node. In a further embodiment, the software component is a firmware element.

In an embodiment, the entity is a person. In a related embodiment, the entity is a robot.

At 1004, biometric data of the entity is received. In an embodiment, receiving biometric data of the entity comprises accessing an image of the entity and analyzing the image to obtain the biometric data.

In an embodiment, receiving biometric data of the entity comprises accessing a sound sample of the entity and analyzing the sound sample to obtain the biometric data.

In an embodiment, receiving biometric data of the entity comprises accessing a fingerprint scan of the entity and analyzing the fingerprint scan to obtain the biometric data.

At 1006, the entity is authenticated using the biometric data.

In an embodiment, authenticating the entity using the biometric data comprises determining that biometric authentication data for the entity is present in a local biometric storage cache of the edge node and authenticating the received biometric data using the biometric authentication data.

In an embodiment, authenticating the entity using the biometric data comprises determining that biometric authentication data for the entity is not present in a local biometric storage cache of the edge node; requesting the biometric authentication data from a second system; and authenticating the received biometric data using the biometric authentication data from the second system. In a further embodiment, the second system is a peer edge node. In another embodiment, the second system is a core network device.

In an embodiment, authenticating the entity using the biometric data comprises: determining that biometric authentication data for the entity is not present in a local biometric storage cache of the edge node and requesting an authentication of the entity from a second system that has access to biometric authentication data for the entity. In a further embodiment, the second system is a peer edge node. In another embodiment, the second system is a core network device.

At 1008, in response to authenticating the entity using the biometric data, access to the feature is granted based on a crosscheck to an access control list that includes entity identifiers correlated to feature identifiers, using the received entity identifier and the received feature identifier.

In an embodiment, granting access to the feature comprises causing a chassis to unlock to provide physical access to the chassis. In another embodiment, granting access to the feature comprises providing access to a basic input-output (BIOS) system of the edge node. In another embodiment, granting access to the feature comprises providing access to an operating system of the edge node. In another embodiment, granting access to the feature comprises providing access to an application executing on the edge node. In another embodiment, granting access to the feature comprises providing access to a physical space that the edge node is installed within.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

### ADDITIONAL NOTES & EXAMPLES

Example 1 is an edge cloud system to implement biometric security for edge platform management, comprising: a biometric sensor; and an edge node in an edge network, the edge node to: receive a request to access a feature of the edge node, the request originating from an entity, wherein the request comprises an entity identifier and a feature identifier; receive from the biometric sensor, biometric data of the entity; authenticate the entity using the biometric data; and in response to authenticating the entity using the biometric data, grant access to the feature based on a crosscheck to an access control list that includes, entity identifiers correlated to feature identifiers, using the received entity identifier and the received feature identifier.

In Example 2, the subject matter of Example 1 includes, wherein the entity is a person.

In Example 3, the subject matter of Examples 1-2 includes, wherein the entity is a robot.

In Example 4, the subject matter of Examples 1-3 includes, wherein the feature comprises a hardware element of the edge node.

In Example 5, the subject matter of Example 4 includes, wherein the hardware element is a memory module.

In Example 6, the subject matter of Examples 4-5 includes, wherein the hardware element is a storage device.

In Example 7, the subject matter of Examples 1-6 includes, wherein the feature comprises a software element of the edge node.

In Example 8, the subject matter of Example 7 includes, wherein the software component is a firmware element.

In Example 9, the subject matter of Examples 1-8 includes, wherein the biometric sensor is a camera, and wherein to receive biometric data of the entity, the biometric sensor is to: access an image of the entity; and analyze the image to obtain the biometric data.

In Example 10, the subject matter of Examples 1-9 includes, wherein the biometric sensor is a microphone, and wherein to receive biometric data of the entity, the biometric sensor is to: access a sound sample of the entity; and analyze the sound sample to obtain the biometric data.

In Example 11, the subject matter of Examples 1-10 includes, wherein the biometric sensor is a fingerprint scanner, and wherein to receive biometric data of the entity, the biometric sensor is to: access a fingerprint scan of the entity; and analyze the fingerprint scan to obtain the biometric data.

In Example 12, the subject matter of Examples 1-11 includes, wherein to authenticate the entity using the biometric data, the edge node is to: determine that biometric authentication data for the entity is present in a local biometric storage cache of the edge node; and authenticate the received biometric data using the biometric authentication data.

In Example 13, the subject matter of Examples 1-12 includes, wherein to authenticate the entity using the biometric data, the edge node is to: determine that biometric authentication data for the entity is not present in a local biometric storage cache of the edge node; request the biometric authentication data from a second system in the edge cloud system; and authenticate the received biometric data using the biometric authentication data from the second system.

In Example 14, the subject matter of Example 13 includes, wherein the second system is a peer edge node.

In Example 15, the subject matter of Examples 13-14 includes, wherein the second system is a core network device.

In Example 16, the subject matter of Examples 1-15 includes, wherein to authenticate the entity using the biometric data, the edge node is to: determine that biometric authentication data for the entity is not present in a local biometric storage cache of the edge node; and request an authentication of the entity from a second system that has access to biometric authentication data for the entity.

In Example 17, the subject matter of Example 16 includes, wherein the second system is a peer edge node.

In Example 18, the subject matter of Examples 16-17 includes, wherein the second system is a core network device.

In Example 19, the subject matter of Examples 1-18 includes, wherein to grant access to the feature, the edge node is to cause a chassis to unlock to provide physical access to the chassis.

In Example 20, the subject matter of Examples 1-19 includes, wherein to grant access to the feature, the edge node is to provide access to a basic input-output (BIOS) system of the edge node.

In Example 21, the subject matter of Examples 1-20 includes, wherein to grant access to the feature, the edge node is to provide access to an operating system of the edge node.

In Example 22, the subject matter of Examples 1-21 includes, wherein to grant access to the feature, the edge node is to provide access to an application executing on the edge node.

In Example 23, the subject matter of Examples 1-22 includes, wherein to grant access to the feature, the edge node is to provide access to a physical space that the edge node is installed within.

Example 24 is a method for biometric security for edge platform management performed in an edge computing environment, comprising: receiving, at an edge node in an edge network, a request to access a feature of the edge node, the request originating from an entity, wherein the request comprises an entity identifier and a feature identifier; receiving biometric data of the entity; authenticating the entity using the biometric data; and in response to authenticating the entity using the biometric data, granting access to the feature based on a crosscheck to an access control list that includes, entity identifiers correlated to feature identifiers, using the received entity identifier and the received feature identifier.

In Example 25, the subject matter of Example 24 includes, wherein the entity is a person.

In Example 26, the subject matter of Examples 24-25 includes, wherein the entity is a robot.

In Example 27, the subject matter of Examples 24-26 includes, wherein the feature comprises a hardware element of the edge node.

In Example 28, the subject matter of Example 27 includes, wherein the hardware element is a memory module.

In Example 29, the subject matter of Examples 27-28 includes, wherein the hardware element is a storage device.

In Example 30, the subject matter of Examples 24-29 includes, wherein the feature comprises a software element of the edge node.

In Example 31, the subject matter of Example 30 includes, wherein the software component is a firmware element.

In Example 32, the subject matter of Examples 24-31 includes, wherein receiving biometric data of the entity comprises: accessing an image of the entity; and analyzing the image to obtain the biometric data.

In Example 33, the subject matter of Examples 24-32 includes, wherein receiving biometric data of the entity comprises: accessing a sound sample of the entity; and analyzing the sound sample to obtain the biometric data.

In Example 34, the subject matter of Examples 24-33 includes, wherein receiving biometric data of the entity comprises: accessing a fingerprint scan of the entity; and analyzing the fingerprint scan to obtain the biometric data.

In Example 35, the subject matter of Examples 24-34 includes, wherein authenticating the entity using the biometric data comprises: determining that biometric authentication data for the entity is present in a local biometric storage cache of the edge node; and authenticating the received biometric data using the biometric authentication data.

In Example 36, the subject matter of Examples 24-35 includes, wherein authenticating the entity using the biometric data comprises: determining that biometric authentication data for the entity is not present in a local biometric storage cache of the edge node; requesting the biometric authentication data from a second system; and authenticating the received biometric data using the biometric authentication data from the second system.

In Example 37, the subject matter of Example 36 includes, wherein the second system is a peer edge node.

In Example 38, the subject matter of Examples 36-37 includes, wherein the second system is a core network device.

In Example 39, the subject matter of Examples 24-38 includes, wherein authenticating the entity using the biometric data comprises: determining that biometric authentication data for the entity is not present in a local biometric storage cache of the edge node; and requesting an authentication of the entity from a second system that has access to biometric authentication data for the entity.

In Example 40, the subject matter of Example 39 includes, wherein the second system is a peer edge node.

In Example 41, the subject matter of Examples 39-40 includes, wherein the second system is a core network device.

In Example 42, the subject matter of Examples 24-41 includes, wherein granting access to the feature comprises causing a chassis to unlock to provide physical access to the chassis.

In Example 43, the subject matter of Examples 24-42 includes, wherein granting access to the feature comprises providing access to a basic input-output (BIOS) system of the edge node.

In Example 44, the subject matter of Examples 24-43 includes, wherein granting access to the feature comprises providing access to an operating system of the edge node.

In Example 45, the subject matter of Examples 24-44 includes, wherein granting access to the feature comprises providing access to an application executing on the edge node.

In Example 46, the subject matter of Examples 24-45 includes, wherein granting access to the feature comprises providing access to a physical space that the edge node is installed within.

Example 47 is an edge computing system, comprising a plurality of edge computing nodes, the plurality of edge computing nodes configured with the biometric security methods of any of Examples 24 to 46.

Example 48 is an edge computing node, operable in an edge computing system, comprising processing circuitry configured to implement any of the methods of Examples 24 to 46.

Example 49 is an edge computing node, operable as a server in an edge computing system, configured to perform any of the methods of Examples 24 to 46.

Example 50 is an edge computing node, operable as a client in an edge computing system, configured to perform any of the methods of Examples 24 to 46.

Example 51 is an edge computing node, operable in a layer of an edge computing network as an aggregation node, network hub node, gateway node, or core data processing node, configured to perform any of the methods of Examples 24 to 46.

Example 52 is an edge computing network, comprising networking and processing components configured to provide or operate a communications network, to enable an edge computing system to implement any of the methods of Examples 24 to 46.

Example 53 is an access point, comprising networking and processing components configured to provide or operate a communications network, to enable an edge computing system to implement any of the methods of Examples 24 to 46.

Example 54 is a base station, comprising networking and processing components configured to provide or operate a communications network, to enable an edge computing system to implement any of the methods of Examples 24 to 46.

Example 55 is a road-side unit, comprising networking components configured to provide or operate a communications network, to enable an edge computing system to implement any of the methods of Examples 24 to 46.

Example 56 is an on-premise server, operable in a private communications network distinct from a public edge computing network, the server configured to enable an edge computing system to implement any of the methods of Examples 24 to 46.

Example 57 is a 3GPP 4G/LTE mobile wireless communications system, comprising networking and processing components configured with the biometric security methods of any of Examples 24 to 46.

Example 58 is a 5G network mobile wireless communications system, comprising networking and processing components configured with the biometric security methods of any of Examples 24 to 46.

Example 59 is a user equipment device, comprising networking and processing circuitry, configured to connect with an edge computing system configured to implement any of the methods of Examples 24 to 46.

Example 60 is a client computing device, comprising processing circuitry, configured to coordinate compute operations with an edge computing system, the edge computing system configured to implement any of the methods of Examples 24 to 46.

Example 61 is an edge provisioning node, operable in an edge computing system, configured to implement any of the methods of Examples 24 to 46.

Example 62 is a service orchestration node, operable in an edge computing system, configured to implement any of the methods of Examples 24 to 46.

Example 63 is an application orchestration node, operable in an edge computing system, configured to implement any of the methods of Examples 24 to 46.

Example 64 is a multi-tenant management node, operable in an edge computing system, configured to implement any of the methods of Examples 24 to 46.

Example 65 is an edge computing system comprising processing circuitry, the edge computing system configured to operate one or more functions and services to implement any of the methods of Examples 24 to 46.

Example 66 is networking hardware with network functions implemented thereupon, operable within an edge computing system configured with the biometric security methods of any of Examples 24 to 46.

Example 67 is acceleration hardware with acceleration functions implemented thereupon, operable in an edge computing system, the acceleration functions configured to implement any of the methods of Examples 24 to 46.

Example 68 is storage hardware with storage capabilities implemented thereupon, operable in an edge computing system, the storage hardware configured to implement any of the methods of Examples 24 to 46.

Example 69 is computation hardware with compute capabilities implemented thereupon, operable in an edge computing system, the computation hardware configured to implement any of the methods of Examples 24 to 46.

Example 70 is an edge computing system adapted for supporting vehicle-to-vehicle (V2V), vehicle-to-everything (V2X), or vehicle-to-infrastructure (V2I) scenarios, configured to implement any of the methods of Examples 24 to 46.

Example 71 is an edge computing system adapted for operating according to one or more European Telecommunications Standards Institute (ETSI) Multi-Access Edge Computing (MEC) specifications, the edge computing system configured to implement any of the methods of Examples 24 to 46.

Example 72 is an edge computing system adapted for operating one or more multi-access edge computing (MEC) components, the MEC components provided from one or more of: a MEC proxy, a MEC application orchestrator, a MEC application, a MEC platform, or a MEC service, according to an European Telecommunications Standards Institute (ETSI) Multi-Access Edge Computing (MEC) configuration, the MEC components configured to implement any of the methods of Examples 24 to 46.

Example 73 is an edge computing system configured as an edge mesh, provided with a microservice cluster, a microservice cluster with sidecars, or linked microservice clusters with sidecars, configured to implement any of the methods of Examples 24 to 46.

Example 74 is an edge computing system, comprising circuitry configured to implement one or more isolation environments provided among dedicated hardware, virtual machines, containers, virtual machines on containers, configured to implement any of the methods of Examples 24 to 46.

Example 75 is an edge computing server, configured for operation as an enterprise server, roadside server, street cabinet server, or telecommunications server, configured to implement any of the methods of Examples 24 to 46.

Example 76 is an edge computing system configured to implement any of the methods of Examples 24 to 46 with use cases provided from one or more of: compute offload, data caching, video processing, network function virtualization, radio access network management, augmented reality, virtual reality, autonomous driving, vehicle assistance, vehicle communications, industrial automation, retail services, manufacturing operations, smart buildings, energy management, internet of things operations, object detection, speech recognition, healthcare applications, gaming applications, or accelerated content processing.

Example 77 is an edge computing system, comprising computing nodes operated by multiple owners at different geographic locations, configured to implement any of the methods of Examples 24 to 46.

Example 78 is a cloud computing system, comprising data servers operating respective cloud services, the respective cloud services configured to coordinate with an edge computing system to implement any of the methods of Examples 24 to 46.

Example 79 is a server, comprising hardware to operate cloudlet, edgelet, or applet services, the services configured to coordinate with an edge computing system to implement any of the methods of Examples 24 to 46.

Example 80 is an edge node in an edge computing system, comprising one or more devices with at least one processor and memory to implement any of the methods of Examples 24 to 46.

Example 81 is an edge node in an edge computing system, the edge node operating one or more services provided from among: a management console service, a telemetry service, a provisioning service, an application or service orchestration service, a virtual machine service, a container service, a function deployment service, or a compute deployment service, or an acceleration management service, the one or more services configured to implement any of the methods of Examples 24 to 46.

Example 82 is a set of distributed edge nodes, distributed among a network layer of an edge computing system, the network layer comprising a close edge, local edge, enterprise edge, on-premise edge, near edge, middle, edge, or far edge network layer, configured to implement any of the methods of Examples 24 to 46.

Example 83 is an apparatus of an edge computing system comprising: one or more processors and one or more computer-readable media comprising instructions that, when executed by the one or more processors, cause the one or more processors to perform any of the methods of Examples 24 to 46.

Example 84 is one or more computer-readable storage media comprising instructions to cause an electronic device of an edge computing system, upon execution of the instructions by one or more processors of the electronic device, to perform any of the methods of Examples 24 to 46.

Example 85 is a communication signal communicated in an edge computing system, to perform any of the methods of Examples 24 to 46.

Example 86 is a data structure communicated in an edge computing system, the data structure comprising a datagram, packet, frame, segment, protocol data unit (PDU), or message, to perform any of the methods of Examples 24 to 46.

Example 87 is a signal communicated in an edge computing system, the signal encoded with a datagram, packet, frame, segment, protocol data unit (PDU), message, or data to perform any of the methods of Examples 24 to 46.

Example 88 is an electromagnetic signal communicated in an edge computing system, the electromagnetic signal carrying computer-readable instructions, wherein execution of the computer-readable instructions by one or more processors causes the one or more processors to perform any of the methods of Examples 24 to 46.

Example 89 is a computer program used in an edge computing system, the computer program comprising instructions, wherein execution of the program by a processing element in the edge computing system is to cause the processing element to perform any of the methods of Examples 24 to 46.

Example 90 is an apparatus of an edge computing system comprising means to perform any of the methods of Examples 24 to 46.

Example 91 is an apparatus of an edge computing system comprising logic, modules, or circuitry to perform any of the methods of Examples 24 to 46.

Example 92 is a system for biometric security for edge platform management performed in an edge computing environment, comprising: a processor; and memory including instructions, which when executed by the processor, cause the processor to perform operations comprising: receiving, at an edge node in an edge network, a request to access a feature of the edge node, the request originating from an entity, wherein the request comprises an entity identifier and a feature identifier; receiving biometric data of the entity; authenticating the entity using the biometric data; and in response to authenticating the entity using the biometric data, granting access to the feature based on a crosscheck to an access control list that includes, entity identifiers correlated to feature identifiers, using the received entity identifier and the received feature identifier.

In Example 93, the subject matter of Example 92 includes, wherein the entity is a person.

In Example 94, the subject matter of Examples 92-93 includes, wherein the entity is a robot.

In Example 95, the subject matter of Examples 92-94 includes, wherein the feature comprises a hardware element of the edge node.

In Example 96, the subject matter of Example 95 includes, wherein the hardware element is a memory module.

In Example 97, the subject matter of Examples 95-96 includes, wherein the hardware element is a storage device.

In Example 98, the subject matter of Examples 92-97 includes, wherein the feature comprises a software element of the edge node.

In Example 99, the subject matter of Example 98 includes, wherein the software component is a firmware element.

In Example 100, the subject matter of Examples 92-99 includes, wherein receiving biometric data of the entity comprises: accessing an image of the entity; and analyzing the image to obtain the biometric data.

In Example 101, the subject matter of Examples 92-100 includes, wherein receiving biometric data of the entity comprises: accessing a sound sample of the entity; and analyzing the sound sample to obtain the biometric data.

In Example 102, the subject matter of Examples 92-101 includes, wherein receiving biometric data of the entity comprises: accessing a fingerprint scan of the entity; and analyzing the fingerprint scan to obtain the biometric data.

In Example 103, the subject matter of Examples 92-102 includes, wherein authenticating the entity using the biometric data comprises: determining that biometric authentication data for the entity is present in a local biometric storage cache of the edge node; and authenticating the received biometric data using the biometric authentication data.

In Example 104, the subject matter of Examples 92-103 includes, wherein authenticating the entity using the biometric data comprises: determining that biometric authentication data for the entity is not present in a local biometric storage cache of the edge node; requesting the biometric authentication data from a second system; and authenticating the received biometric data using the biometric authentication data from the second system.

In Example 105, the subject matter of Example 104 includes, wherein the second system is a peer edge node.

In Example 106, the subject matter of Examples 104-105 includes, wherein the second system is a core network device.

In Example 107, the subject matter of Examples 92-106 includes, wherein authenticating the entity using the biometric data comprises: determining that biometric authentication data for the entity is not present in a local biometric storage cache of the edge node; and requesting an authentication of the entity from a second system that has access to biometric authentication data for the entity.

In Example 108, the subject matter of Example 107 includes, wherein the second system is a peer edge node.

In Example 109, the subject matter of Examples 107-108 includes, wherein the second system is a core network device.

In Example 110, the subject matter of Examples 92-109 includes, wherein granting access to the feature comprises causing a chassis to unlock to provide physical access to the chassis.

In Example 111, the subject matter of Examples 92-110 includes, wherein granting access to the feature comprises providing access to a basic input-output (BIOS) system of the edge node.

In Example 112, the subject matter of Examples 92-111 includes, wherein granting access to the feature comprises providing access to an operating system of the edge node.

In Example 113, the subject matter of Examples 92-112 includes, wherein granting access to the feature comprises providing access to an application executing on the edge node.

In Example 114, the subject matter of Examples 92-113 includes, wherein granting access to the feature comprises providing access to a physical space that the edge node is installed within.

Example 115 is at least one machine-readable medium including instructions for biometric security for edge platform management performed in an edge computing environment, which when executed by a machine, cause the machine to perform operations comprising: receiving, at an edge node in an edge network, a request to access a feature of the edge node, the request originating from an entity, wherein the request comprises an entity identifier and a feature identifier; receiving biometric data of the entity; authenticating the entity using the biometric data; and in response to authenticating the entity using the biometric data, granting access to the feature based on a crosscheck to an access control list that includes, entity identifiers correlated to feature identifiers, using the received entity identifier and the received feature identifier.

In Example 116, the subject matter of Example 115 includes, wherein the entity is a person.

In Example 117, the subject matter of Examples 115-116 includes, wherein the entity is a robot.

In Example 118, the subject matter of Examples 115-117 includes, wherein the feature comprises a hardware element of the edge node.

In Example 119, the subject matter of Example 118 includes, wherein the hardware element is a memory module.

In Example 120, the subject matter of Examples 118-119 includes, wherein the hardware element is a storage device.

In Example 121, the subject matter of Examples 115-120 includes, wherein the feature comprises a software element of the edge node.

In Example 122, the subject matter of Example 121 includes, wherein the software component is a firmware element.

In Example 123, the subject matter of Examples 115-122 includes, wherein receiving biometric data of the entity comprises: accessing an image of the entity; and analyzing the image to obtain the biometric data.

In Example 124, the subject matter of Examples 115-123 includes, wherein receiving biometric data of the entity comprises: accessing a sound sample of the entity; and analyzing the sound sample to obtain the biometric data.

In Example 125, the subject matter of Examples 115-124 includes, wherein receiving biometric data of the entity comprises: accessing a fingerprint scan of the entity; and analyzing the fingerprint scan to obtain the biometric data.

In Example 126, the subject matter of Examples 115-125 includes, wherein authenticating the entity using the biometric data comprises: determining that biometric authentication data for the entity is present in a local biometric storage cache of the edge node; and authenticating the received biometric data using the biometric authentication data.

In Example 127, the subject matter of Examples 115-126 includes, wherein authenticating the entity using the biometric data comprises: determining that biometric authentication data for the entity is not present in a local biometric storage cache of the edge node; requesting the biometric authentication data from a second system; and authenticating the received biometric data using the biometric authentication data from the second system.

In Example 128, the subject matter of Example 127 includes, wherein the second system is a peer edge node.

In Example 129, the subject matter of Examples 127-128 includes, wherein the second system is a core network device.

In Example 130, the subject matter of Examples 115-129 includes, wherein authenticating the entity using the biometric data comprises: determining that biometric authentication data for the entity is not present in a local biometric storage cache of the edge node; and requesting an authentication of the entity from a second system that has access to biometric authentication data for the entity.

In Example 131, the subject matter of Example 130 includes, wherein the second system is a peer edge node.

In Example 132, the subject matter of Examples 130-131 includes, wherein the second system is a core network device.

In Example 133, the subject matter of Examples 115-132 includes, wherein granting access to the feature comprises causing a chassis to unlock to provide physical access to the chassis.

In Example 134, the subject matter of Examples 115-133 includes, wherein granting access to the feature comprises providing access to a basic input-output (BIOS) system of the edge node.

In Example 135, the subject matter of Examples 115-134 includes, wherein granting access to the feature comprises providing access to an operating system of the edge node.

In Example 136, the subject matter of Examples 115-135 includes, wherein granting access to the feature comprises providing access to an application executing on the edge node.

In Example 137, the subject matter of Examples 115-136 includes, wherein granting access to the feature comprises providing access to a physical space that the edge node is installed within.

Example 138 is an apparatus for providing biometric security for edge platform management performed in an edge computing environment, the apparatus comprising: means for receiving, at an edge node in an edge network, a request to access a feature of the edge node, the request originating from an entity, wherein the request comprises an entity identifier and a feature identifier, means for receiving biometric data of the entity; means for authenticating the entity using the biometric data; and means for in response to authenticating the entity using the biometric data, granting access to the feature based on a crosscheck to an access control list that includes, entity identifiers correlated to feature identifiers, using the received entity identifier and the received feature identifier.

In Example 139, the subject matter of Example 138 includes, wherein the entity is a person.

In Example 140, the subject matter of Examples 138-139 includes, wherein the entity is a robot.

In Example 141, the subject matter of Examples 138-140 includes, wherein the feature comprises a hardware element of the edge node.

In Example 142, the subject matter of Example 141 includes, wherein the hardware element is a memory module.

In Example 143, the subject matter of Examples 141-142 includes, wherein the hardware element is a storage device.

In Example 144, the subject matter of Examples 138-143 includes, wherein the feature comprises a software element of the edge node.

In Example 145, the subject matter of Example 144 includes, wherein the software component is a firmware element.

In Example 146, the subject matter of Examples 138-145 includes, wherein the means for receiving biometric data of the entity comprises: means for accessing an image of the entity; and means for analyzing the image to obtain the biometric data.

In Example 147, the subject matter of Examples 138-146 includes, wherein the means for receiving biometric data of the entity comprises: means for accessing a sound sample of the entity; and means for analyzing the sound sample to obtain the biometric data.

In Example 148, the subject matter of Examples 138-147 includes, wherein the means for receiving biometric data of the entity comprises: means for accessing a fingerprint scan of the entity; and means for analyzing the fingerprint scan to obtain the biometric data.

In Example 149, the subject matter of Examples 138-148 includes, wherein the means for authenticating the entity using the biometric data comprises: means for determining that biometric authentication data for the entity is present in a local biometric storage cache of the edge node; and means for authenticating the received biometric data using the biometric authentication data.

In Example 150, the subject matter of Examples 138-149 includes, wherein the means for authenticating the entity using the biometric data comprises: means for determining that biometric authentication data for the entity is not present in a local biometric storage cache of the edge node; means for requesting the biometric authentication data from a second system; and means for authenticating the received biometric data using the biometric authentication data from the second system.

In Example 151, the subject matter of Example 150 includes, wherein the second system is a peer edge node.

In Example 152, the subject matter of Examples 150-151 includes, wherein the second system is a core network device.

In Example 153, the subject matter of Examples 138-152 includes, wherein the means for authenticating the entity using the biometric data comprises: means for determining that biometric authentication data for the entity is not present in a local biometric storage cache of the edge node; and means for requesting an authentication of the entity from a second system that has access to biometric authentication data for the entity.

In Example 154, the subject matter of Example 153 includes, wherein the second system is a peer edge node.

In Example 155, the subject matter of Examples 153-154 includes, wherein the second system is a core network device.

In Example 156, the subject matter of Examples 138-155 includes, wherein the means for granting access to the feature comprises means for causing a chassis to unlock to provide physical access to the chassis.

In Example 157, the subject matter of Examples 138-156 includes, wherein the means for granting access to the feature comprises means for providing access to a basic input-output (BIOS) system of the edge node.

In Example 158, the subject matter of Examples 138-157 includes, wherein the means for granting access to the feature comprises means for providing access to an operating system of the edge node.

In Example 159, the subject matter of Examples 138-158 includes, wherein the means for granting access to the feature comprises means for providing access to an application executing on the edge node.

In Example 160, the subject matter of Examples 138-159 includes, wherein the means for granting access to the feature comprises means for providing access to a physical space that the edge node is installed within.

Example 161 is at least one machine-readable medium including instructions that, when executed by processing circuitry, cause the processing circuitry to perform operations to implement of any of Examples 1-160.

Example 162 is an apparatus comprising means to implement of any of Examples 1-160.

Example 163 is a system to implement of any of Examples 1-160.

Example 164 is a method to implement of any of Examples 1-160.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. An edge cloud system to implement biometric security for edge platform management, comprising:
a biometric sensor; and
an edge node in an edge network, the edge node to:
receive a request to access a feature of the edge node, the request originating from an entity, wherein the request comprises an entity identifier and a feature identifier;
receive from the biometric sensor, biometric data of the entity;
authenticate the entity using the biometric data; and
in response to authenticating the entity using the biometric data, grant access to the feature based on a crosscheck to an access control list that includes entity identifiers correlated to feature identifiers, using the received entity identifier and the received feature identifier.

2. The edge cloud system of claim 1, wherein the entity is a person.

3. The edge cloud system of claim 1, wherein the entity is a robot.

4. The edge cloud system of claim 1, wherein the feature comprises a hardware element of the edge node.

5. The edge cloud system of claim 4, wherein the hardware element is a memory module.

6. The edge cloud system of claim 4, wherein the hardware element is a storage device.

7. The edge cloud system of claim 1, wherein the feature comprises a software element of the edge node.

8. The edge cloud system of claim 7, wherein the software component is a firmware element.

9. The edge cloud system of claim 1, wherein the biometric sensor is a camera, and wherein to receive biometric data of the entity, the biometric sensor is to:
access an image of the entity; and
analyze the image to obtain the biometric data.

10. The edge cloud system of claim 1, wherein the biometric sensor is a microphone, and wherein to receive biometric data of the entity, the biometric sensor is to:
access a sound sample of the entity; and
analyze the sound sample to obtain the biometric data.

11. The edge cloud system of claim 1, wherein the biometric sensor is a fingerprint scanner, and wherein to receive biometric data of the entity, the biometric sensor is to:
access a fingerprint scan of the entity; and
analyze the fingerprint scan to obtain the biometric data.

12. The edge cloud system of claim 1, wherein to authenticate the entity using the biometric data, the edge node is to:
determine that biometric authentication data for the entity is present in a local biometric storage cache of the edge node; and
authenticate the received biometric data using the biometric authentication data.

13. The edge cloud system of claim 1, wherein to authenticate the entity using the biometric data, the edge node is to:
determine that biometric authentication data for the entity is not present in a local biometric storage cache of the edge node;
request the biometric authentication data from a second system in the edge cloud system; and
authenticate the received biometric data using the biometric authentication data from the second system.

14. The edge cloud system of claim 13, wherein the second system is a peer edge node.

15. The edge cloud system of claim 13, wherein the second system is a core network device.

16. The edge cloud system of claim 1, wherein to authenticate the entity using the biometric data, the edge node is to:
determine that biometric authentication data for the entity is not present in a local biometric storage cache of the edge node; and
request an authentication of the entity from a second system that has access to biometric authentication data for the entity.

17. The edge cloud system of claim 16, wherein the second system is a peer edge node.

18. The edge cloud system of claim 16, wherein the second system is a core network device.

19. The edge cloud system of claim 1, wherein to grant access to the feature, the edge node is to cause a chassis to unlock to provide physical access to the chassis.

20. The edge cloud system of claim 1, wherein to grant access to the feature, the edge node is to provide access to a basic input-output (BIOS) system of the edge node.

21. The edge cloud system of claim 1, wherein to grant access to the feature, the edge node is to provide access to an operating system of the edge node.

22. The edge cloud system of claim 1, wherein to grant access to the feature, the edge node is to provide access to an application executing on the edge node.

23. The edge cloud system of claim 1, wherein to grant access to the feature, the edge node is to provide access to a physical space that the edge node is installed within.

24. A system for biometric security for edge platform management performed in an edge computing environment, comprising:
a processor; and
memory including instructions, which when executed by the processor, cause the processor to perform operations comprising:
receiving, at an edge node in an edge network, a request to access a feature of the edge node, the request originating from an entity, wherein the request comprises an entity identifier and a feature identifier,
receiving biometric data of the entity;
authenticating the entity using the biometric data; and
in response to authenticating the entity using the biometric data, granting access to the feature based on a crosscheck to an access control list that includes entity identifiers correlated to feature identifiers, using the received entity identifier and the received feature identifier.

25. The system of claim 24, wherein authenticating the entity using the biometric data comprises:
determining that biometric authentication data for the entity is present in a local biometric storage cache of the edge node; and
authenticating the received biometric data using the biometric authentication data.

26. At least one machine-readable medium including instructions for biometric security for edge platform management performed in an edge computing environment, which when executed by a machine, cause the machine to perform operations comprising:
receiving, at an edge node in an edge network, a request to access a feature of the edge node, the request originating from an entity, wherein the request comprises an entity identifier and a feature identifier,
receiving biometric data of the entity;
authenticating the entity using the biometric data; and
in response to authenticating the entity using the biometric data, granting access to the feature based on a crosscheck to an access control list that includes entity identifiers correlated to feature identifiers, using the received entity identifier and the received feature identifier.

27. The machine-readable medium of claim 26, wherein authenticating the entity using the biometric data comprises:
determining that biometric authentication data for the entity is not present in a local biometric storage cache of the edge node;
requesting the biometric authentication data from a second system; and
authenticating the received biometric data using the biometric authentication data from the second system.
